(19) United States
(12) Patent Application Publication
(10) Pub. No.: US 2024/0016196 A1
(43) Pub. Date: Jan. 18, 2024

(54) EDIBLE FOOD ADHESIVE FILMS

(71) Applicant: Tastee Tape, LLC, Baltimore, MD (US)

(72) Inventors: Tyler Brooke Guarino, Baltimore, MD (US); Marie Eric, Baltimore, MD (US); Marc Donohue, Baltimore, MD (US); Rachel Nie, Baltimore, MD (US); Erin Kathleen Walsh, Baltimore, MD (US)

(73) Assignee: Tastee Tape, LLC, Baltimore, MD (US)

(21) Appl. No.: 18/354,590

(22) Filed: Jul. 18, 2023

Related U.S. Application Data
(63) Continuation of application No. PCT/US2023/070454, filed on Jul. 18, 2023.
(60) Provisional application No. 63/390,205, filed on Jul. 18, 2022.

(51) Int. Cl. A23P 20/20; A23P 20/15; A23L 29/30; A23L 29/262; A23L 29/256

(52) U.S. Cl. CPC A23P 20/20; A23P 20/15; A23L 29/30; A23L 29/262; A23L 29/256; A23L 29/37

(57) ABSTRACT

The present disclosure is related to adhesive composite films which may be used to attach to food materials, and potentially form unions between food materials. These adhesive composite films generally comprise a backbone layer having one or more adhesive layers disposed thereon. They may be used to join many food-based materials often used as external barriers in foodstuffs such as tortillas, gyros, and pitas.

### CROSS REFERENCE TO RELATED APPLICATIONS

The present application claims priority to U.S. App. No. 63/390,205, filed on Jul. 18, 2022, which is hereby incorporated by reference in its entirety.

### FIELD OF DISCLOSURE

The present disclosure is related to edible food adhesive films. These adhesive films are typically composite materials which resemble tape and can be used in the assembly, during consumption, and flavoring of food products. These films may contain a backbone, for example, made with a fibrous or polymeric material having an adhesive layer deposited thereon.

### BACKGROUND

Many foods such as sandwiches, burritos, and gyros contain an external, edible, and typically starch based material surrounding various ingredients placed within the external material. These external materials afford the ability for a user to consume the foodstuff without the need for utensils or to avoid potential contact with the contents. However, if these items are constructed poorly, or even if they are constructed well, there is always a chance of the external material separating or tearing, allowing the ingredients within to fall out. Even a simple act of overfilling these eternal materials can result in tears material which causes the structural integrity of the foodstuff to erode making them significantly more difficult to eat.

Some consumers, cooks, and restaurants have attempted to solve this issue by wrapping these food products such as burritos or gyros with an inedible material such as aluminum foil, plastic wrap, or paper to contain the food item in its entirety. However, in order to consume the food, this wrapping must be torn away in sections or awkwardly unwrapped to reveal the food underneath. This process can also lead to an additional mess, accidental consumption of the outer wrapping, excess waste, and other issues. Moreover, wrapping the food item in its entirety, especially when the food is warm, traps the rising steam and condensation leading the wrap/tortilla itself to become soggy and unstable.

Additionally, without the use of such an outer wrapping, consumers of certain of these materials with an edible external barrier, such as burritos, gyros, and pitas, have a limited amount of filling space available for the internal foods. This may lead to customers being overcharged for the amount of food received and consumers experiencing hunger later in the day due to not eating enough at mealtime.

To address these issues, the market, including restaurants and consumers, has started offering items such as “burrito bowls” or “gyro bowls.” These are deconstructed versions of the original food stuffs and offer a less messy replacement. However, these options also lead to an increase in plastic waste due to the need for single-use bowls and utensils. Moreover (and some would say importantly), these bowls do not fulfill the experience of eating an actual burrito, taco, gyro, wrap, and other food items by hand.

It is therefore an object of this disclosure to provide a material that can be used with these foodstuffs to avoid these, and other problems often encountered with these products.

### SUMMARY

In accordance with the foregoing objectives and others, the present disclosure provides edible film (e.g., tape) capable of binding to the external material. Binding the material may provide additional support to the material and provide various benefit such as avoidance of tears in the material, make eating the compiled foodstuff easier, increase the available filling space (e.g., allow more internal components be added with a reduced likelihood of tears or food blowouts (e.g., flood pushing through the edible barrier) or other breakdowns in structural integrity), and provide structural support to the material. In some embodiments, the edible film may be placed at specific points in the material (e.g., such as at the union of two portions of a tortilla). In some embodiments, the edible film may surround a portion of the food product.

The edible food adhesive film may be a composite material which may comprise (or consist essentially of or consist of an edible backbone (e.g., an edible, food-grade polymeric material) and an adhesive coating. Generally, the edible backbone layer is an edible material formed into planar structure that offers the film the ability to bend and form to the shape of the food product. The adhesive coating may be placed on (e.g., cover) one surface of the edible backbone. In some embodiments, the adhesive coating may be placed on (e.g., cover) two surfaces of the edible backbone. In some embodiments, the adhesive coating may cover at least 50% or at least 60% or at least 70% or at least 80% or at least 90% or at least 95% or at least 99% or 100% of the surface area of a surface of a surface of the edible backbone.

These materials may be used to keep food items in place or together during consumption. The backbone may comprise a material, such a polymer and/or fiber (e.g., dietary fiber) which provides structural support to the backbone layer. For example, polymers useful in the edible backbone can be high-strength and/or cross-linked. In some embodiments, the backbone layer comprises a dietary fiber (e.g., a water-soluble dietary fiber such as psyllium or dextrin (e.g., wheat dextrin such as supplied from Benefiber), a gelatin (e.g., beef gelatin), an alginate (e.g., sodium alginate). In some embodiments, the backbone layer may comprise a sweetener such as sugar and/or a gelling agent such as calcium lactate. In some embodiments the backbone layer includes a dietary fiber comprising more than 60% or more than 70% or more than 80% or more than or more than 90% or more than or more than 95% psyllium by volume of the dietary fiber. In some embodiments, the backbone layer comprises less than 30% or less than 20% or less than 10% or less than 5% or less than 1% or less than 0.5% or less than 0.1% by volume starch (e.g., potato starch, arrowroot). In some embodiments, the backbone layer does not comprise starch. In some embodiments, the backbone layer comprises less than 30% or less than 20% or less than 10% or less than 5% or less than 1% or less than or less than 0.1% by volume gum (e.g., xanthan gum, guar gum) by volume of the backbone layer. In some embodiments, the backbone layer does not comprise gum. In some embodiments, the backbone layer comprises a mixture of dietary fibers (e.g., psyllium, wheat dextrin), wherein one of the dietary fibers (e.g., psyllium) is the predominant dietary fiber in the backbone layer (e.g., the backbone layer comprises two dietary fibers (e.g., psyllium and another dietary fiber such as wheat dextrin), wherein one of the dietary fibers (e.g., psyllium) is present at more than 50% or more than 60% or more than 70% or more than 80% or more than 90% or more than 95% or more than 99% by volume of the dietary fibers).

In some embodiments, the dietary fiber may include a mix of soluble and insoluble fibers. Surprisingly, it has been found that the backbone can include both the soluble fiber and insoluble fiber and maintain the appropriate characteristics to produce an adhesive composite film with characteristics consistent with the films of the present disclosure (e.g., viscosity, strength, bendability, transparency, adhesiveness). For example, the weight ratio of soluble fiber to insoluble fiber in the backbone layer may be from, for example, 10:1 to 1:1 (e.g., 7:1 to 2:1, 6:1 to 4:1). It was found that backbone layers comprising a weight ratio of soluble fiber to insoluble 6:1 to 4:1 produced particularly suited adhesive composite films. In some embodiments, the dietary fiber comprises (including consists essentially of) psyllium (e.g., psyllium husk powder). In some embodiments, the dietary fiber comprises (including consists essentially of) psyllium having a weight ratio of soluble fiber to insoluble fiber in the backbone layer may be from, for example, 10:1 to 1:1 (e.g., 7:1 to 2:1, 6:1 to 4:1).

In certain aspects, the backbone layer comprises (or consists essentially of) a dietary fiber (e.g., psyllium), and optionally a sweetener (e.g., sugar), optionally an adhesive and/or binder (e.g., tylose powder, a methylcellulose such as carboxymethylcellulose), and a plasticizer (e.g., xylitol, sorbitol, or combinations thereof). The backbone layer may comprise (or consist essentially of), for example, psyllium and optionally, sugar, optionally a plasticizer, and adhesive (e.g., tylose powder), and optionally one or more flavoring agents. In some embodiments, the volume ratio of the dietary fiber to sweetener is from 10:1 to 1:10 (e.g., 2:1 to 1:2).

In some embodiments, the edible backbone layer may comprise a plasticizer such as xylitol, sorbitol, or combinations thereof. In some embodiments, the backbone layer comprises a volume ratio (the volume ratio may be identified upon initial mixing with, for example, water, and prior to dehydration) of dietary fiber to plasticizer of from 10:1 to 1:10 (e.g., from 5:1 to 1:5, from 4:1 to 1:4, from 3:1 to 1:4, from 3:2 to 2:5). In some embodiments, the backbone layer comprises a weight ratio of dietary fiber to plasticizer of from 20:1 to 1:20 (e.g., from to 1:15, from 10:1 to 1:10, from 8:1 to 1:8, from 5:1 to 1:5, from 7:2 to 1:2, from 5:2 to 2:3). In some embodiments, the backbone layer comprises a volume ratio (the volume ratio may be identified upon initial mixing with, for example, water, and prior to dehydration) of dietary fiber to plasticizer of from 10:1 to 1:10 (e.g., from 5:1 to 1:5, from 3:1 to 1:3, from 2:1 to 1:3, from 3:2 to 2:5). In particular embodiments, the backbone layer may comprise a volume ratio of psyllium to sorbitol of from 4:1 to 1:10 (e.g., from 3:1 to 1:10, from 4:1 to 1:4, from 4:1 to 1:3). In certain aspects, the backbone layer may comprise a volume ratio of psyllium to xylitol of from 2:1 to 1:3 (e.g., 3:2 to 2:5). In particular embodiments, the backbone layer may comprise a weight ratio of psyllium to sorbitol of from 10:1 to 1:10 (e.g., from 7:1 to 1:7 from 6:1 to 1:6, from 5:1 to 1:6, from 7:1 to 1:3, from 7:1 to 1:3). In certain aspects, the backbone layer may comprise a weight ratio of psyllium to xylitol of from 3:1 to 1:4 (e.g., 5:2 to 2:5). These materials may offer additional advantages such as providing an opacity and/or translucency to the material. In some embodiments, the edible backbone can comprise 5% to 50% of a dietary polymer, 0% to 20% sugar, and 0% to 50% adhesive polymers, weight/weight. In some embodiments, the edible adhesive film that can be flavored (e.g., add one or more flavoring agents) to add certain tastes to the food item being consumed.

The adhesive layer may comprise (or consist of) an adhesive such as, for example, tylose (e.g., dextrin, carboxymethylcellulose, and sugar), dextrin, a hydroxyalkylcellulose, a cellulose derivative such as carboxymethylcellulose, a cellulose gum, glucomannan powder, soy lecithin, a sweetener such as sugar, or combinations thereof. In some embodiments, the adhesive layer comprises less than 50% starch by volume of the adhesive layer (e.g., less than 40% starch, less than 30% starch, less than 20% starch, less than 10% starch, less than 5% starch, less than 1% starch, less than 0.5% starch). In some embodiments, the adhesive layer comprises less than 50% starch by weight of the adhesive layer (e.g., less than 40% starch, less than 30% starch, less than 20% starch, less than 10% starch, less than 5% starch, less than 1% starch, less than 0.5% starch). The adhesive layer may be formed by mixing the adhesive in a suitable medium (e.g., water, boiling water) under mixing and with optional application of heat to result in an adhesive composition for concomitant use with the backbone layer material. Exemplary tylose compositions for use in the present disclosure include Tylose Powder available from Confectionary Arts International. In some embodiments, the adhesive comprises a cellulosic material (e.g., a cellulose ether, hydroxyalkylcellulose, carboxymethylcellulose, a cellulose gum such as carboxymethylcellulose which may have, for example, a molecular weight of less than 100 kDa (e.g., from 0.1 kDa to 100 kDa, from 15 kDa to 90 kDa), and a dextrin (e.g., a dextrin having a dextrose equivalent of, for example, less than 15% (e.g., from 1-15%, from 1-13%), and a sweetener (e.g., sugar). In some embodiments, the adhesive comprises from 1-50% carboxyalkylcellulose, from 1-50% sweetener, and from 1-50% dextrin.

In some embodiments, the backbone layer comprises less than 30% or less than 20% or less than 10% or less than 5% or less than 1% or less than 0.5% or less than 0.1% by volume starch (e.g., potato starch, arrowroot) by volume of the adhesive layer. In some embodiments, the backbone layer does not comprise starch.

The present disclosure also provides methods of making an edible backbone and adhesive coating. Generally, these methods involve the formation of the edible backbone into a shape appropriate for making adjoining or surrounding portions of a food product and application of the adhesive film to at least one surface into the shaped edible backbone. The edible backbone, for example, may be constructed by dissolving a dietary fiber (e.g., psyllium) and optionally a sweetener (e.g., sugar), optionally an adhesive (e.g., tylose powder), and optionally a plasticizer (e.g., xylitol, sorbitol, combinations thereof) in a medium (e.g., water). They may be combined in a volume ratio, of solids (e.g., dietary fiber, adhesive, plasticizer, sweetener) to water of from 1:1 to 1:10 (e.g., 1:1 to 1:5, 1:1 to 1:2). The components may be mixed until a homogenous mixture is obtained (e.g., for a time period of more than (or up to 2 hours) 5 minutes, more than 10 minutes, more than 15 minutes). Mixing may occur under the influence of heat (e.g., a low heat). In some embodiments, the components may be ground with, for example a chop grinder or a burr grinder, to reduce the particle size. For example, the powder may be ground with a Mueller Austria HyperGrind Precision Electric Spice/Coffee Grinder Mill prior to mixing with a dissolution medium (e.g., water). The powder, prior to mixing in the dissolution medium, may have a weight average particle size of less than (or from 0.1 μm to) 500 μm (e.g., less than 200 μm, less than 100 μm, less than 80 μm, less than 70 μm, less than 50 μm, from 1 μm to 200 μm, from 1 μm to 100 μm, from 1 μm to 80 μm, from 1 μm to 70 μm, from 1 μm to 50 μm, from 10 μm to 200 μm, from 10 μm to 100 μm, from 10 μm to 80 μm, from 10 μm to 70 μm, from 10 μm to 50 μm). In some embodiments, the powder, prior to mixing in the dissolution medium, has a number average particle size of less than (or from 0.1 μm to) 500 μm (e.g., less than 200 μm, less than 100 μm, less than 80 μm, less than 70 μm, less than 50 μm, from 1 μm to 200 μm, from 1 μm to 100 μm, from 1 μm to 80 μm, from 1 μm to 70 μm, from 1 μm to 50 μm, from 10 μm to 200 μm, from 10 μm to 100 μm, from 10 μm to 80 μm, from 10 μm to 70 μm, from 10 μm to 50 μm). Particle sizes may be measured, for example, by Dynamic Light Scattering.

Following mixing, the material may be dehydrated (e.g., heated to remove water) for a time period sufficient for water removal (e.g., more than (or up to a week), 12 hours, more than 18 hours, more than 24 hours). In some embodiments, dehydration may occur by application of heating. In some embodiments, dehydration may occur via refrigeration. Dehydration may occur by spreading the mixed material onto a substrate, such as wax paper or plastic wrap to dry. In some embodiments, the adhesive (e.g., tylose) is additionally mixed into the material. Separately, the adhesive composition may be made by mixing an adhesive (e.g., tylose) in a medium (e.g., water, boiling water) with constant mixing until, for example, a homogenous mixture is formed. The adhesive composition may be mixed for, for example, for more than (or up to 2 hours) 5 minutes, 10 minutes, or fifteen minutes. In some embodiments, adhesive composition (e.g., tylose composition) is applied to the backbone following dehydration. In some embodiments, adhesive (e.g., tylose composition) is applied to the backbone prior to dehydration.

Methods of preparing foodstuffs are also provided. These methods may involve applying the edible film of the present disclosure to one portion of a first edible barrier material (e.g., tortilla, pita, bread) and adhering that portion to another portion of a second edible barrier material. In some embodiments, the first edible barrier material and the second barrier material are the same edible barrier material (e.g., the same tortilla adjoined at different positions). These methods may include filling the edible barrier material with the internal components (e.g., meats, vegetables, cheeses, sauces, or combinations thereof) prior to adhering the two edible barrier materials. In some embodiments, the first application of the edible film occurs after placing the interna components in or on the edible barrier material.

### BRIEF DESCRIPTION OF FIGURES

FIG. 1 illustrates a perspective view of an edible adhesive film illustrating an exemplary cross section across the height of the material. In this example, there are two distinct layers, the bottom containing the backbone and the top containing the adhesive.

FIG. 2 illustrates an aerial view of the embodiment packaged onto a release-layer with multiple pre-cut edible adhesive tapes on a single sheet.

FIG. 3 illustrates a three-layer version of the adhesive film, with the backbone in the middle and a layer of an adhesive on each side (for a total of two).

### DETAILED DESCRIPTION

Detailed embodiments of the present disclosure are disclosed herein; however, it is to be understood that the disclosed embodiments are merely illustrative of the disclosure that may be embodied in various forms. In addition, each of the examples given in connection with the various embodiments of the disclosure is intended to be illustrative, and not restrictive.

All terms used herein are intended to have their ordinary meaning in the art unless otherwise provided. All concentrations are in terms of percentage by weight of the specified component relative to the entire weight of the topical composition, unless otherwise defined.

As used herein, “a” or “an” shall mean one or more. As used herein when used in conjunction with the word “comprising,” the words “a” or “an” mean one or more than one. As used herein “another” means at least a second or more.

As used herein, all ranges of numeric values include the endpoints and all possible values disclosed between the disclosed values. The exact values of all half-integral numeric values are also contemplated as specifically disclosed and as limits for all subsets of the disclosed range. For example, a range of from 0.1% to 3% specifically discloses a percentage of 0.1%, 1%, 1.5%, 2.0%, 2.5%, and 3%. Additionally, a range of 0.1 to 3% includes subsets of the original range including from 0.5% to 2.5%, from 1% to 3%, from 0.1% to 2.5%, etc. It will be understood that the sum of all weight % of individual components will not exceed 100%. Each numerical value, whether or not modified by the word “about,” may embrace uncertainties and equivalences associated with measurement of the particular parameter identified. Each numerical value may be exactly that value if indicated or be within, for example, 10% or 5% or 1% as indicated herein.

By “consist essentially” it is meant that the ingredients include only the listed components along with the normal impurities present in commercial materials and with any other additives present at levels which do not affect the operation of the embodiments disclosed herein, for instance at levels less than 5% by weight or less than 1% or even 0.5% by weight.

Provided herein is an edible adhesive film for food. Items of food such as tortillas, wraps, gyros, breads, edible papers, doughs can be wrapped through using the adhesive edible tape described herein to adjoin two portions of food. In some embodiments, the two portions are on the same food, such as a tortilla, wrap, or gyro, and can connect two portions of the food in order to contain other internal components of a food product (e.g., burrito, taco, gyro, shawarma, roti roll, spring rolls, gyoza, dumplings, calzone, sushi).

Typically, the adhesive film is a composite material formed from a layer of edible adhesive disposed over a backbone layer. In some embodiments, the adhesive film is a composite material comprising three layers, two separate adhesive layers separated by the backbone.

Backbone Layer

Provided is a strength-containing backbone layer. The edible strength-containing elements (polymers, polysaccharides, edible polymers, edible natural and synthetic papers) provides a surface onto which the adhesive may be applied or is integrated within the element. The strength-containing elements can be formed into individual strips that are placed onto packaging materials (such as wax paper, parchment paper, food-grade plastics, films, aluminum foil, plastic wrap).

In one embodiment, the backbone layer (e.g., fibrous backbone) is less than (or from (0.005 mm to) to 0.5 mm thick in the dehydrated form. It may be pre-formed into strips of lengths ranging from 10 to 20 mm and widths ranging from 20 to 100 mm in the dehydrated form. The backbone layer can contain a range of water content of, for example, 50-80% by weight in the rehydrated form. In some embodiments, the backbone layer can comprise 1-50% weight/weight of polymer and/or fibrous materials (e.g., psyllium) in its rehydrated form.

The strength-containing element (backbone) can be formed through a mixture of separate solutions that form the backbone having a sufficient strength to support the adhesive, but a flexibility sufficient to not break when in use. Various combinations of materials may be used in formation of the backbone layer. For example, the backbone layer may comprise psyllium, sodium carboxymethyl cellulose (Na-CMC, or just CMC), gum tragacanth, xanthan gum, karaya gum, beta glucan, wheat dextrin, an alginate (e.g., sodium alginate) and calcium polycarbonphil. Additional examples include crosslinking sodium alginate with a magnesium- or calcium-containing salt such as calcium chloride, magnesium chloride, calcium lactate or magnesium gluconate. Additional examples of polymers include acacia, guar gum, arrowroot powder, potato starch, gelatin, agar, pullulan, chitosan, pectin, methylcellulose, inulin. Examples of solvents include water. Sugar can be an optional additive.

The strength-containing element can be heated with a solvent (e.g., water) to initiate crosslinking, polymerization, or gel-formation.

Examples of strength-containing compounds include psyllium, sodium carboxymethyl cellulose (Na-CMC, or just CMC), gum tragacanth, xanthan gum, karaya gum, beta glucan, wheat dextrin, and calcium polycarbonphil. Additional examples include crosslinking sodium alginate with a magnesium- or calcium-containing salt such as calcium chloride, magnesium chloride, calcium lactate or magnesium gluconate. Additional examples of polymers include acacia, guar gum, arrowroot powder, potato starch, gelatin, agar, pullulan, chitosan, pectin, methylcellulose, inulin. Examples of solvents include water. Sugar can be an optional additive.

The layers including the backbone layer may comprise a sweetener such as a sugar, stevia, or aspartame. Sugars can include cane sugar, beet sugar, coconut sugar, honey, agave, maple syrup, and molasses. Non-sugar substitutes can also be used, particularly if they have good crosslinking property.

Typically, the dietary fiber includes may be either a polysaccharides or lignin. The fibers or dietary fibers described in the present disclosure may not be digested by the endogenous secretion of the human digestive tract. A dietary fiber or fiber may be soluble fiber, which dissolves in water or an insoluble fiber, which do not dissolve in water. Insoluble fiber can be metabolically inert and can provide bulking and/or strengthening properties to food and/or prebiotic benefits. Non-limiting examples of sources of soluble fiber can include psyllium, beta glucan, oat bran, oat groat, pectin, carrageenan, guar gum, locust bean gum, gum acacia, xanthan gum, and combinations thereof.

The dietary fiber may be fiber derived from plants, including fruits, vegetables, legumes, grains, and nuts, among others. In certain embodiments, the fiber may be derived from one or more of the following plants: acai, aloe, apple, apricot, banana, blackberry, blueberry, boysenberry, cantaloupe, cherry, coffee, tea, coconut, corn, cranberry, date, elderberry, fig, gooseberry, grape, grapefruit, citrus, guava, honeydew, kiwi, konjac, kumquat, lemon, lime, mango, nectarine, orange, papaya, passion fruit, peach, pear, persimmon, pineapple, plantain, plum, pomegranate, prune, pumpkin, raspberry, star fruit, strawberry, tangerine, tomato, watermelon, avocado, cabbage, carrot, celery, cucumber, elderflower, kale, leek, potato, spinach, zucchini, oats, barley, rye, chia, soy, psyllium seed husks, almonds, pistachios, peanuts, macadamia nuts, walnuts, pecans, and sunflower seeds. The person of ordinary skill in the art will appreciate that other types of fruit, vegetables, plants, legumes, grains, and nuts may be alternatively or additionally used. The fiber may be from a combination of various fruits, vegetables, plants, legumes, grains, and nuts; the person ordinary skill will appreciate that different blends of fruit and vegetables can provide different flavors and consistencies to any layer described herein (e.g., the backbone layer).

An exemplary fiber for use in the backbone material is psyllium which may be ground psyllium or ispaghula husk. Psyllium may be obtained (e.g., extracted) from the seeds of Plantago ovata or Plantago psyllium. In one example, the psyllium husk is from Plantago ovata. In particular embodiments, the psyllium (or the soluble fiber present in the backbone layer) may be Now Foods Psyllium Husk powder soluble fiber.

The backbone may comprise (or comprise predominantly) water-soluble polymers such as guar gum, glucommannan, psyllium, gum acacia, polyethylene glycol, polyvinylpyrrolidone, hydroxypropyl methylcellulose, and other cellulose ethers such as methylcellulose, and sodium carboxymethylcellulose. These include, but are not limited to, gelatin, natural sugars such as raw sugar or lactose, lecithin, mucilage, plant gums, pectins or pectin derivatives, algal polysaccharides, glucomannan, agar and lignin, guar gum, locust bean gum, acacia gum, xanthan gum, carrageenan gum, karaya gum, tragacanth gum, ghatti gum, starches (e.g., corn starch or amylose), dextran, polyvinyl pyrrolidone, polyvinyl acetate, gum arabic, alginic acid, tylose, talcum, lycopodium, silica gel (e.g., colloidal), cellulose and cellulose derivatives (e.g., cellulose ethers, cellulose ethers in which the cellulose hydroxy groups are partially etherified with lower saturated aliphatic alcohols and/or lower saturated, aliphatic oxyalcohols; e.g., methyloxypropyl cellulose, methyl cellulose, hydroxypropyl methyl cellulose, hydroxypropyl methyl cellulose phthalate, cross-linked sodium carboxymethylcellulose, cross-linked hydroxypropylcellulose, high-molecular weight hydroxymethylpropylcellulose, carboxymethyl-cellulose, low-molecular weight hydroxypropylmethylcellulose medium-viscosity hydroxypropylmethylcellulose hydroxyethylcellulose, hydroxypropylcellulose, hydroxypropylmethylcellulose, sodium carboxymethylcellulose, alkylcelluloses, ethyl cellulose, cellulose acetate, cellulose propionate (low, medium or high molecular weight), cellulose acetatepropionate, cellulose acetate butyrate, cellulose triacetate, methyl cellulose, hydroxypropyl cellulose, orhydroxypropylmethyl cellulose), fatty acids as well as magnesium, calcium or aluminum salts of fatty acids with 12 to 22 carbon atoms, in particular saturated fatty acids (e.g., stearates such as magnesium stearate), polycarboxylic acids, emulsifiers, oils and fats, in particular vegetable (e.g., peanut oil, castor oil, olive oil, sesame oil, cottonseed oil, corn oil, wheat germ oil, sunflower seed oil, cod liver oil, in each case also optionally hydrated); glycerol esters and polyglycerol esters of saturated fatty acids (e.g., C₁₂H₂₄O₂ to C₁₈H₃₆O₂) and their mixtures, it being possible for the glycerol hydroxy groups to be totally or also only partly esterified (e.g., mono-, di- and triglycerides); high melting point hydrogenated vegetable oils suitable for microencapsulation; pharmaceutically acceptable mono- or multivalent alcohols and polyglycols such as polyethylene glycol and derivatives thereof, esters of aliphatic saturated or unsaturated fatty acids (e.g., 2 to 22 carbon atoms, e.g., 10-18 carbon atoms) with monovalent aliphatic alcohols (e.g., 1 to 20 carbon atoms) or multivalent alcohols such as glycols, glycerol, diethylene glycol, pentacrythritol, sorbitol, mannitol and the like, which may optionally also be etherified, esters of citric acid with primary alcohols, acetic acid, urea, benzyl benzoate, dioxolanes, glyceroformals, tetrahydrofurfuryl alcohol, polyglycol ethers with C₁-C₁₂ alcohols, dimethylacetamide, lactamides, lactates, ethylcarbonates, silicones (e.g., medium-viscous polydimethyl siloxanes), calcium carbonate, sodium carbonate, calcium phosphate, sodium phosphate, magnesium carbonate and the like.

Typically, the backbone layer also comprises one or more plasticizers. As shown herein the plasticizer and polymer/fibrous combinations significantly alter the properties of the backbone layer to result in viable backbone products suitable within the context of the present disclosure. In some embodiments, the plasticizer may comprise a sugar alcohol plasticizer. The sugar alcohol plasticizer can be isomalt, maltitol, sorbitol, xylitol, erythritol, adonitol, dulcitol, pentaerythritol, or mannitol, for example. In a particular aspect, the sugar alcohol plasticizer can be sorbitol or a sorbitol-containing plasticizer such as isomalt. The polyol plasticizer can be isomalt, maltitol, sorbitol, xylitol, erythritol, adonitol, dulcitol, pentaerythritol, or mannitol, glycerin, diglycerin, ethylene glycol, diethylene glycol, triethyleneglycol, tetraethylene glycol, a polyethylene glycol up to 400 MW, neopentyl glycol, propylene glycol, 1,3-propanediol, 2-methyl-1,3-propanediol, trimethylolpropane, or a polyether polyol, for example. The plasticizer, when present, may be selected from polyethylene glycol, glycerol, sorbitol, xylitol, and a combination thereof. Typically, the backbone layer comprises a plasticizer which is selected from glycerol, sorbitol, xylitol, and a combination thereof. In some embodiments, the film comprises a plasticizer which is selected from glycerol, sorbitol, xylitol, and a combination thereof.

In particular embodiments, the plasticizer is selected from xylitol, sorbitol, and a combination thereof. In some embodiments, a single plasticizer (e.g., sorbitol, xylitol) is the only or predominant plasticizer in the film. The backbone may comprise from 0% to 40% by weight of each plasticizer present, preferably from 1% to 35% by weight of each plasticizer, more preferably from 2% to 30% by weight of each plasticizer, and most preferably from 3% to 25% by weight of each plasticizer. Without wishing to be bound by any particular theory, it is believed that the addition of plasticizers, e.g. a combination of sorbitol, xylitol, sorbitol and xylitol, increases the flexibility and pliability of the films, reducing brittleness. It is believed this makes the films easier to handle and use. Only certain plasticizers, such as xylitol or sorbitol, may be used with the polymeric and/or fibrous material (e.g., psyllium) to result in a viable backbone layer of the present disclosure.

In some embodiments, the backbone layer further comprises one or more seasoning agents (which may, for example, lessen the sweetness provided by the plasticizer). For example, the backbone layer may comprise salt, vinegar (e.g., apple cider vinegar such as distilled and/or filtered and/or pasteurized apple cider vinegar, white vinegar such as distilled and/or filtered and/or pasteurized white vinegar), mirin, soy sauce, amino acids (such as glycine, alanine, sodium glutamate, or combinations thereof), nucleic acid based seasonings such as sodium inosinate, sodium guanylate, or combinations thereof), organic acid based seasonings such as sodium succinate, fruit juices, proteins, and spices. It has been found that the backbone layers, including those with the plasticizer, can tolerate an amount of seasoning (which may also help reduce the sweetness of the composite adhesive films). For example, in some embodiments, the weight ratio of plasticizer to seasoning agent may be from 1:1 to 25:1 (e.g., 2:1 to 20:1, 3:1 to 20:1, 3:1 to 15:1, 3:1 to 12:1, 5:1 to 20:1, 5:1 to 18:1). In some embodiments, the plasticizer is xylitol and the seasoning agent is salt and/or vinegar. In some embodiments, the plasticizer is xylitol and the seasoning agent is salt and/or vinegar and the weight ratio of plasticizer to seasoning agent is from 1:1 to 25:1 (e.g., 2:1 to 20:1, 3:1 to 20:1, 3:1 to 15:1, 3:1 to 12:1, 5:1 to 20:1, 5:1 to 18:1). In some embodiments, the plasticizer is xylitol and the seasoning agent is salt and/or vinegar. In some embodiments, the plasticizer is sorbitol and the seasoning agent is salt and/or vinegar and the weight ratio of plasticizer to seasoning agent is from 1:1 to 25:1 (e.g., 2:1 to 20:1, 3:1 to 20:1, 3:1 to 15:1, 3:1 to 12:1, 5:1 to 20:1, 5:1 to 18:1).

An exemplary backbone layer includes:
a) more than 20% (e.g., 20%-99%, 30%-99%, 40%-99%, 50%-99%, 60%-99%, 20%-95%, 30%-95%, 40%-95%, 50%-95%, 60%-95%, 20%-90%, 30%-90%, 40%-90%, 50%-90%, 60%-90%, 20%-80%, 30%-80%, 40%-80%, 50%-80%, 60%-80%) polymer or dietary fiber (e.g., a blend of soluble and insoluble fibers, psyllium, a blend of psyllium soluble fiber and insoluble fiber) by weight of the backbone layer;
b) optionally less than (or from 0.1% to) 50% (e.g., 1%-50%, 5%-50%, 10%-50%, 20%-50%, 30%-50%, 1%-40%, 5%-40%, 10%-40%, 20%-40%, 30%-40%, 1%-30%, 5%-30%, 10%-30%, 20%-30%, 1%-20%, 5%-20%, 10%-20%) plasticizer (e.g., sorbitol, xylitol, or a combination thereof) by weight of the backbone layer; and c) optionally less than (or from 0.1% to) 20% (e.g., 1%-20%, 5%-20%, 10%-20%, 1%-15%, 5%-15%, 10%-15%, 15%-20%, 1%-10%, 5%-10%, 1%-5%) adhesive and/or binder (e.g., tylose powder, carboxymethylcellulose, dextrin, sweetener) by weight of the backbone layer;
d) optionally less than (or from 0.1% to) 20% (e.g., 1%-20%, 5%-20%, 10%-20%, 1%-15%, 5%-15%, 10%-15%, 15%-20%, 1%-10%, 5%-10%, 1%-5%) seasoning agent (e.g., salt, vinegar, distilled white vinegar) by weight of the backbone layer; and e) optionally less than (or from 0.1% to) 20% (e.g., 1%-20%, 5%-20%, 10%-20%, 1%-15%, 5%-15%, 10%-15%, 15%-20%, 1%-10%, 5%-10%, 1%-5%) sweetener (e.g., sugar) by weight of the backbone layer.

Adhesive Layer

In one embodiment, the edible tape can be activated for use through the addition of water to rehydrate the strength-containing element and/or adhesive. Alternatively, it can be activated through heat from an oven, microwave, pan, or residual from the edible element. It can also be pre-activated form that is ready-to-use upon removal from packaging.

The adhesive coating/layer can be an edible element with sticky properties that allow the adhering of one or two elements. This can be in the format of emulsifiers, sugars, and gums.

The adhesive element can be placed on the surface of the strength-containing elements in a dehydrated or hydrated format. The adhesive element can also be placed within the strength-containing element, creating a sticky strength-containing element during manufacturing. The adhesive can also be placed onto one side of the material or on both sides, creating a double-sided tape. The double-sided embodiment can be placed between two dough elements to minimize visual appearance by the consumer.

In one embodiment, the adhesive coating/layer is an organic, edible, water-soluble adhesive coating. In the dehydrated form, it ranges in thickness 0.01 to 0.1 mm. It is placed on one side of the fibrous backbone in a dehydrated state. The adhesive is able to be re-activated into its original state through hydration, providing a sticky surface for adhesion.

The adhesive layer may include one or more components as described for other layers as well (e.g., sweeteners, fibers, plasticizers). For example, the adhesive layer may comprise a sweetener (e.g., sugar), a dextrin (e.g., a dextrin having a dextrose equivalent of less than 15%), and a cellulose derivatives (e.g., cellulose ethers, cellulose ethers in which the cellulose hydroxy groups are partially etherified with lower saturated aliphatic alcohols and/or lower saturated, aliphatic oxyalcohols; e.g., methyloxypropyl cellulose, methyl cellulose, hydroxypropyl methyl cellulose, hydroxypropyl methyl cellulose phthalate, cross-linked sodium carboxymethylcellulose, cross-linked hydroxypropylcellulose, high-molecular weight hydroxymethylpropylcellulose, carboxymethyl-cellulose, low-molecular weight hydroxypropylmethylcellulose medium-viscosity hydroxypropylmethylcellulose hydroxyethylcellulose, hydroxypropylcellulose, hydroxypropylmethylcellulose, sodium carboxymethylcellulose, alkylcelluloses, ethyl cellulose, cellulose acetate, cellulose propionate (low, medium or high molecular weight), cellulose acetatepropionate, cellulose acetate butyrate, cellulose triacetate, methyl cellulose, hydroxypropyl cellulose, orhydroxypropylmethyl cellulose). In particular embodiments, the adhesive comprises carboxymethylcellulose. In some embodiments, the adhesive layer comprises tylose. Exemplary tylose compositions for use in the present disclosure include Tylose Powder available from Confectionary Arts International. In some embodiments, the adhesive comprises a cellulosic material (e.g., a cellulose ether, hydroxyalkylcellulose, a cellulose derivative, a cellulose gum such as carboxymethylcellulose which may have, for example, a molecular weight of less than 100 kDa (e.g., from 0.1 kDa to 100 kDa, from 15 kDa to 90 kDa), and a dextrin (e.g., a dextrin having a dextrose equivalent of, for example, less than 15% (e.g., from 1-15%, from 1-13%), and a sweetener (e.g., sugar). In some embodiments, the adhesive comprises from 1-50% (e.g., 5%-50%, 10%-50%, 20%-50%, 30%-50%, 1%-40%, 5%-40%, 10%-40%, 20%-40%, 30%-40%, 1%-30%, 5%-30%, 10%-30%, 20%-30%, 1%-20%, 5%-20%, 10%-20%) cellulose derivative (e.g., carboxymethylcellulose), from 1-50% (e.g., 5%-50%, 10%-50%, 20%-50%, 30%-50%, 1%-40%, 5%-40%, 10%-40%, 20%-40%, 30%-40%, 1%-30%, 5%-30%, 10%-30%, 20%-30%, 1%-20%, 5%-20%, 10%-20%) sweetener, and from 1-50% dextrin (e.g., 5%-50%, 10%-50%, 20%-50%, 30%-50%, 1%-40%, 5%-40%, 10%-40%, 20%-40%, 30%-40%, 1%-30%, 5%-30%, 10%-30%, 20%-30%, 1%-20%, 5%-20%, 10%-20%) by weight of the adhesive layer.

Additional Components

The adhesive layer and/or backbone layer may independently further comprise an additional component such as an opacifying agent, coloring agent, or flavoring agent. For example, the composite material (e.g., the adhesive layer, the backbone layer) may comprise artificial and natural food coloring, spices, essences, extracts, flavorings, and combinations thereof. The flavoring agent, for example, when present, may for example be selected from acacia, anise oil, caraway oil, cardamom, cherry syrup, cinnamon, citric acid syrup, clove oil, cocoa, coriander oil, ethyl vanillin, fennel oil, ginger, glycerin, glycyrrhiza, honey, lavender oil, lemon oil, mannitol, nutmeg oil, orange oil, orange flower water, peppermint oil, raspberry, rose oil, rosewater, rosemary oil, sarsaparilla syrup, spearmint oil, thyme oil, tolu balsam syrup, vanilla, wild cherry syrup, and mixtures thereof. The film may comprise from 0.001% to 10% by weight of each additional agent present, preferably from 0.01% to 5% by weight of each additional agent, and most preferably from 0.1% to 3% by weight of each additional agent.

Forming the Adhesive Composite Film

The present disclosure also provides methods of making an edible backbone and adhesive coating. Generally, these methods involve the formation of the edible backbone into a shape appropriate for making adjoining or surrounding portions of a food product and application of the adhesive film to at least one surface into the shaped edible backbone. The edible backbone, for example, may be constructed by dissolving a dietary fiber (e.g., psyllium) and optionally a sweetener (e.g., sugar), optionally an adhesive (e.g., tylose powder), and optionally a plasticizer (e.g., xylitol, sorbitol, combinations thereof) in a medium (e.g., water). The components may be mixed until a homogenous mixture is obtained. Mixing may occur under the influence of heat (e.g., a low heat). Following mixing, the material may be dehydrated for a time period sufficient for water removal. Separately, the adhesive composition may be made by mixing an adhesive (e.g., tylose) in a medium (e.g., water, boiling water) with constant mixing until, for example, a homogenous mixture is formed.

The adhesive composition is then generally applied to one side of the backbone composition. In some embodiments, adhesive (e.g., tylose composition) is applied to the backbone prior to dehydration. In some embodiments, the composite film is dehydrated such that the adhesiveness is lost. In these embodiments, a user may add water to the film to increase the adhesive properties and create a hydrated adhesive film suitable for adjoining food products.

Generally, both the backbone layer and the adhesive layer are planar having the adhesive layer disposed on one or both planar surfaces of the backbone. The height ratio of the backbone layer to each adhesive layer may be, for example, from 2:1 to 1:2 (e.g., from 2:1 to 1:1, from 1:1 to 1:2). In some embodiments, the backbone layer has a height of less than (or from 0.1 mm to) 1 mm (e.g., less than 0.5 mm, less than 0.25 mm, less than 0.15 mm). In some embodiments, the adhesive layer has a height of less than (or from 0.1 mm to) 1 mm (e.g., less than 0.5 mm, less than 0.25 mm, less than 0.15 mm). In some embodiments, the composite film has a height of less than (or from 0.1 mm to) 1 mm (e.g., less than 0.5 mm, less than 0.35 mm, less than 0.3 mm, less than 0.25 mm).

The adhesive composite film may comprise (including consist essentially of):
a) more than 50% backbone layer (e.g., more than 60%, more than 70%, more than 80%, more than 90%, more than 95%, 50%-99%, 60%-99%, 70%-99%, 80%-99%, 90%-99%, 50%-95%, 60%-95%, 70%-95%, 80%-95%, 90%-95%, 50%-90%, 60%-90%, 70%-90%, 80%-90%, 50%-80%, 60%-80%, 70%-80%) by weight of the adhesive composite film; and
b) less than 50% adhesive layer (e.g., 1%-50%, 5%-50%, 10%-50%, 20%-50%, 30%-50%, 1%-40%, 5%-40%, 10%-40%, 20%-40%, 30%-40%, 1%-30%, 5%-30%, 10%-30%, 20%-30%, 1%-20%, 5%-20%, 10%-20%) by weight of the adhesive composite film.

The adhesive film can be a dry and flexible material. It can contain sticky and/or wet elements (e.g., adhesive or the backbone) that can be packaged with materials that separate one layer of the adhesive film from another (such as Release layer, wax paper, parchment paper, food-grade plastics, films, aluminum foil, plastic wrap), to prevent user exposure to said wet and sticky elements.

The adhesive film is generally created to be foldable and able to stick to a food barrier material such as a starch-based food barrier material (e.g., tortilla, gyro, pita). In some embodiments, the adhesive film can have clear color and no taste. In another embodiment, the adhesive film can contain a color and/or taste through the addition of coloring and flavoring elements (such as artificial and natural food coloring, spices, essences, extracts, flavorings). The texture (and for the most part visibility) of the adhesive film may not be noticeable and can be concealed within the consumption of the edible items.

In one embodiment, the adhesive film is a product with clear color, no taste, dry, and flexible with the purpose of adhering to food elements. The adhesive film can have a fibrous backbone with organic, water-soluble, edible adhesive coating on one side of the backbone.

The composite film may be packaged with the adhesive side oriented onto a separation substrate wax paper for easy removal. The product may require water activation prior to use. Dehydration during the manufacturing process may minimize consumer mess while handling and reduce stickiness of the material. In some embodiments, there is an adhesive layer on both sides of the composite film, and each adhesive film is oriented onto a separation substrate such as wax paper.

A large sheet of the backbone can be cut or broken into differently sized smaller fragments or with pre-defined perforations or indentations that can be separated by the user. The backbone can also be in a roll that the user can unwind to reveal the adhesive element. In some embodiments, the adhesive film is produced in sheets having length and/or width dimensions of from 1″ to 15.″ These sheets may be cut into smaller strips (e.g., strips having a width of, for example less than 1.5″ (e.g., 0.1″-1.5″. 0.1″-0.5″). The strips may have a length of, for example less than (or from 0.1″ to) 15″ (e.g., 0.5″-1″, 1″-2″, 2″-3″, 3″-4″, 4″-5″, 6″-7″, 7″-8″, 8″-9″, 9″-10″, 10″-11″, 11″-12″, 12″-13″, 13″-14″, 14″-15″). The adhesive film may be a large sheet as well. These large sheets may be used to surround larger portions of a product. For example, a large sheet may be used to wrap a sandwich, burrito, or gyro.

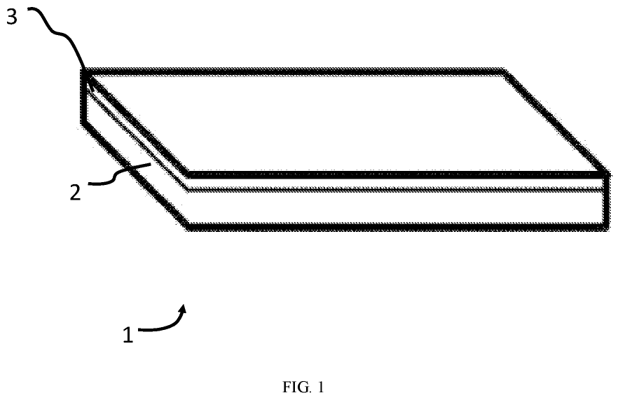

Referring now to FIG. 1, a perspective view of adhesive composite film 1 is provided showing the backbone layer 2 and adhesive layer 3. As can be seen, the backbone layer 2 is planar having adhesive layer 3 disposed across one of the surfaces. The height of the composite film across the cross section is illustrated in the figure.

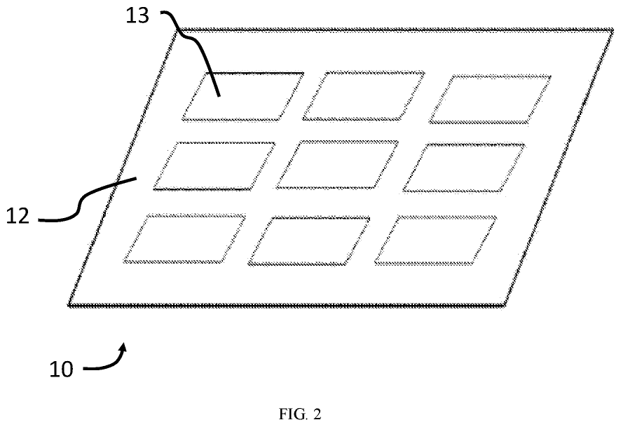

Referring now to FIG. 2, a packaged kit 10 of the present disclosure is provided. The kit comprises a plurality of adhesive composite films 13 disposed on a transfer substrate (e.g., wax paper, parchment paper) 12. In the embodiment depicted, the kit comprises 9 individual transfer surfaces. In some embodiments, each substrate may comprise from, for example 2-20 individual adhesive composite films. In some embodiments, the kit comprises a plurality of substrate materials, each substrate material having a plurality of adhesive films deposited thereon. In some embodiments, the adhesive films may have two adhesive surfaces, and, for example, a second transfer substrate disposed over each adhesive surface.

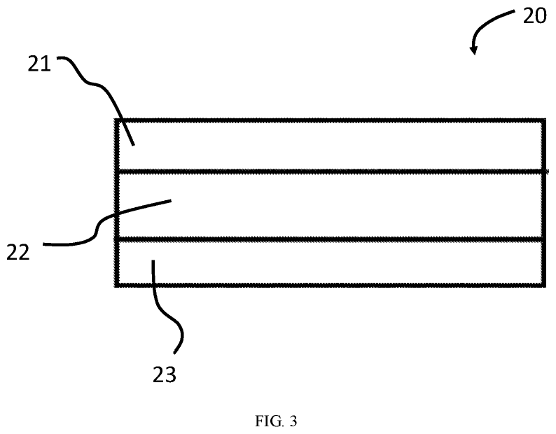

Referring now to FIG. 3, a cross section of a double sided adhesive composite material 20 is shown. Adhesive composite film comprises planar backbone section 22. One surface of planar backbone section 22 is covered by adhesive surface 21 and the opposite surface of planar backbone section 22 is covered by adhesive surface 23. In some embodiments, adhesive surface 21 and adhesive surface 23 are formed from the same adhesive composition (e.g., tylose based adhesive formulations). Adhesive composite film 20 has three layers. The backbone can be in the middle, with a first layer of the adhesive placed on the bottom and a second layer on the top of the backbone.

The following brands of compounds can be used (e.g., food grade versions) in the adhesive composite films of the present disclosure:
Psyllium: Himalaya Organic Psyllium Whole Husk for Daily Fiber, Weight Management, Cholesterol and Blood Sugar Support, 12 oz, 56 Tablespoon Supply
Tylose: Confectionery Arts International Professional Strength Tylose Powder, 2 Ounce
Acacia: Anthony's Organic Acacia Senegal Powder
Guar Gum: Herbaila 100% Pure & Natural Guar Gum Powder
Xanthan Gum: MD.Life Xanthan Gum FFC Amylase Free Gluten Free
Arrowroot Powder: Its's Just
Potato Starch: Kate Naturals Organic Potato Starch
Gelatin: Beef

The adhesive composite film can comprise 1% to 50% of a polymer or fiber (such as those listed above), 0% (or 0.1% to) to 20% sugar, and 0% (or 0.1% to) to 50% adhesive materials, weight/weight. In some embodiments, the adhesive composite film comprises 1-10% polymer, 1-5% sugar, and 1-10% adhesive material, w/w (e.g., in hydrated form).

The formed strength-containing element can be spread thinly and dehydrated to remove substantial amounts of solvent from the product.

The adhesive can be formulated through a rigorous mixing process or gentle shaking over an extended period of time with the powdered adhesive and the appropriate solvent.

In certain formations, the adhesive is integrated into the strength-containing element formation process. Alternatively, it can be spread thinly onto one or two sides of the strength-containing element. In one aspect, it may be dehydrated onto the backbone or placed in packaging in the hydrated state.

A process included within the present disclosure involves the heating of the fibrous backbone material and water to allow for gel formation. The hydrated fibrous backbone is spread thinly for dehydration at low heat (e.g., 150-250° Fahrenheit), for approximately 60 to 120 minutes. The adhesive may be formulated through vigorous mixing of the powder and water. The adhesive may be spread thinly onto the dehydrated backbone and placed onto packaging. This formulation may be dehydrated once again. Dehydrated formulations often have lost adhesive properties. To regain adhesive properties, water may be added to the formulation (e.g., prior to contact with an external barrier food material).

### EXAMPLES

The following examples illustrate specific aspects of the instant description. The examples should not be construed as limiting, as the example merely provides specific understanding and practice of the embodiments and its various aspects.

### Example 1: Psyllium Backbone Recipe

Table 1 provides an exemplary backbone polymer formulation. The components were mixed in order to form a material for subsequent dehydration. The adhesive formulation of Table 3 was integrated into the formulation.

TABLE 1

| Ingredient | Quantity |
|---|---|
| Water | 227 g |
| Psyllium | 9 g |
| Sugar | 13 g |
| Adhesive | 1 (recipe in Table 3) |

### Example 2: Sodium Alginate Backbone Recipe

Table 2 provides an exemplary backbone polymer formulation. The components were mixed in order to form a material for subsequent dehydration. The adhesive formulation of Table 3 was integrated into the formulation

TABLE 2

| Ingredient | Quantity |
|---|---|
| Water | 200 g |
| Calcium Lactate | 1 g |
| Sodium Alginate | 1 g |
| Adhesive | 1 (recipe in Table 3) |

### Example 3: Tylose Adhesive Recipe

Table 3 provides an exemplary adhesive formulation. The components were mixed in order to form an adhesive formulation. This adhesive formulation may be integrated into a backbone formulation of the present application and/or used to form an adhesive layer on the backbone formulation (e.g., a dehydrated backbone formulation).

TABLE 3

| Ingredient | Quantity |
|---|---|
| Water | 119 g |
| Tylose | 5 g |

### Example 4: Exemplary Formulations

### Polymer (fiber) Recipes

Tylose Adhesive:
Ingredients:
   1 tsp tylose powder
   ½ cup water
Steps:
   Combine using a frother until thick and all clumps have been dissolved

Psyllium Backbone:
Ingredients:
   8 oz water
   1 tbsp psyllium, whole husk
   Tylose adhesive (see above for recipe)
Steps:
   Combine water and psyllium in pan and stir over low heat (a 2 on the stove, 110° F.) for 5 minutes
   Spread mixture on a silicon baking sheet
   Bake in oven at 200° F. for approximately an hour or until dry
   Peel backbone off silicone baking mat
   Cut into strips (currently 2 in by 0.5 in but can be changed to fit end need)
   Spread tylose adhesive on back of strip and place adhesive side down onto a sheet of wax paper to dry
How to use:
   Peel strip off wax paper
   Thoroughly wet to activate
   Apply to food item (side on wax paper is side that goes onto food)

Psyllium+Acacia Backbone:
Ingredients:
   8 oz water
   1 tbsp psyllium, whole husk
   1 tbsp acacia senegal powder
   Tylose adhesive (see above for recipe)
Steps:
   Combine water, acacia, and psyllium in pan and stir over low heat (a 2 on the stove, 110° F.) for 5 minutes
   Spread mixture on a silicon baking sheet
   Bake in oven at 200° F. for approximately an hour or until dry
   Peel backbone off silicone baking mat
   Cut into strips (currently 2 in by 0.5 in but can be changed to fit end need)
   Spread tylose adhesive on back of strip and place adhesive side down onto a sheet of wax paper to dry
How to use:
   Peel strip off wax paper
   Thoroughly wet to activate
   Apply to food item (side on wax paper is side that goes onto food)

### Example 5: Viability Assessment of Individual Layers and Composite Films

Several adhesive compositions were prepared. Their viability associated for parameters associated with constructing and using the adhesive composite films of the present disclosure was assessed. Table 4 provides the adhesive formulations tested.

TABLE 4

| Materials | Medium | Process |
|---|---|---|
| ¾ tsp Tylose | 1 cup boiling water | constant mixing for 15 minutes, refrigerate in air tight |
| | | container overnight (24 hours min) |
| ¾ tsp Tylose | ½ cup boiling | constant mixing for 15 minutes, refrigerate in air tight |
| | water | container overnight (24 hours min) |
| ¾ tsp Tylose, ¾ tsp | 1 cup boiling water | constant mixing for 15 minutes, refrigerate in air tight |
| corn starch | | container overnight (24 hours min) |
| ½ tsp glucomannan | 3 tsp water | mixed for an extended period of time |
| powder | | |
| ¼ tsp glucomannan | 2 tbsp water | mixed for an extended period of time |
| powder | | |
| ¼ tsp glucomannan | 4 tbsp water | mixed for an extended period of time |
| powder | | |
| ¼ tsp glucomannan | 8 tbsp water | mixed for an extended period of time |
| powder | | |
| ¼ tsp soy lecithin | 1 tbsp water (boiled | mix, optionally store in refrigerator to thicken |
| | and cooled) | overnight |

Parameters evaluated included strength of adhesiveness to starch based external foods (e.g., tortilla), film formation ability, texture, consistency, opacity, and viscosity. Table 5 details the viability for each adhesive composition as applied across these metrics.

TABLE 5

| Materials (from Table 4) | Parameter Assessment | Viability |
|---|---|---|
| ¾ tsp Tylose (1 cup | excellent sticking to tortilla, can withstand pull forces of | Most Viable |
| water) | typical burrito, burrito tears before tylose shears | |
| ¾ tsp Tylose (½ cup | thicker recipe to create a film of sorts but was unable to due to | Most Viable |
| tylose) | solution saturation point, still sticky and strong as prior recipe | |
| ¾ tsp Tylose, ¾ tsp | thicker, opaque, white substance (texture of pudding), not as | Less Viable |
| corn starch | strong as just tylose recipe | |
| ½ tsp glucomannan | not able to dissolve and clumps together fairly quickly | Less Viable |
| powder | | |
| ¼ tsp glucomannan | clumpy, sticks to itself but not to other surfaces, acts more | Least Viable |
| powder | like a thickening agent than an adhesive | |
| ¼ tsp glucomannan | clumpy, sticks to itself but not to other surfaces, acts more | Least Viable |
| powder | like a thickening agent than an adhesive | |
| ¼ tsp glucomannan | clumpy, sticks to itself but not to other surfaces, acts more | Least Viable |
| powder | like a thickening agent than an adhesive | |
| ¼ tsp soy lecithin | quite aqueous, too thin, during pull test with tortilla, was | Least Viable |
| | unable to stick two pieces together | |

As can be seen, tylose based adhesive produced the most viable adhesives. Additionally, the concentration of tylose in the blend had a resultant effect on the formulation as well. Application of starches, such as cornstarch, to tylose based adhesives, degraded viability.

Backbone compositions were also prepared and evaluated. Table 7 provides the formulations assessed.

TABLE 7

| Materials | Water | Process |
|---|---|---|
| ½ packet Jello Gelatin | 2 tbsp | combined then boiled, spread on thin baking sheet, set for |
| | | 8+ hours and cut into strips |
| ¾ tsp tylose | ½ cup water | spread thin onto aluminum sheet, baked in oven for 225 F. for |
| | | 3 hours |
| ¾ tsp tylose, 1 tbsp | 1 cup water | spread thin onto aluminum sheet, baked in oven for 225 F. for |
| cornstarch | | 1.5 hours |
| ¾ tsp tylose, 1 tbsp | 1 cup water | spread thin onto aluminum sheet, baked in oven for 225 F. for |
| cornstarch, 2 tsp flour | | 1.5 hours |
| ¾ tsp tylose, 1 tbsp | 1 cup water | spread thin onto aluminum sheet, baked in oven for 225 F. for |
| cornstarch, 4 tsp flour | | 1.5 hours |
| 1 tsp beef gelatin | 2 tsp water | spread thin onto aluminum sheet, baked in oven for 225 F. for |
| | | 3 hours |
| 1 tbsp psyllium husk, 1 tbsp | 4 oz water | combine ingredients, boil on low heat, cool on parchment |
| benefiber | | paper |
| 1 tbsp psyllium husk, 1 tbsp | 3 tbsp water | combine ingredients, boil on low heat, cool on parchment |
| benefiber, 1 tbsp maple | | paper |
| syrup | | |
| 1 tsp psyllium husk, 1 tsp | ¾ cup + 2 | Combine water and sugar and boil for 4 minutes, combine |
| benefiber, 6 tbsp sugar | tbsp water | ¾ cup water and fibers, add fiber mixture to sugar mixture |
| | | and bring to boil, remove sample after 5 minutes |
| 1 tsp psyllium husk, 1 tsp | ¾ cup + 2 | Combine water and sugar and boil for 4 minutes, combine |
| benefiber, 6 tbsp sugar | tbsp water | ¾ cup water and fibers, add fiber mixture to sugar mixture |
| | | and bring to boil, remove sample after 10 minutes |
| 1.5 tbsp benefiber | 8 oz boiling | bring water to boil, add fiber, continue mixing on high heat |
| | water | for 5 minutes |
| 6 tbsp benefiber, 1 tbsp | 4 oz water | bring water to boil, add fiber and sugar , continue mixing on |
| sugar | | high heat |
| 2 tbsp psyllium | 4 oz water | bring water to boil, add fiber, stir 1 min and take off heat |
| 2 tbsp psyllium | 8 oz water | bring water to boil, add fiber, stir 1 min and take off heat |
| 1 tbsp psyllium, 1 tbsp sugar | 8 oz water | mix ingredients, put on low heat for 3 minutes |
| 1 tbsp psyllium, 1 tbsp sugar | 8 oz water | mix ingredients, put on low heat for 7 minutes |
| 1 tbsp psyllium, 1 tbsp sugar | 4 oz water | mix ingredients, put on low heat for 3 minutes |
| 3 tbsp benefiber, ½ tbsp | 2 oz water | mix ingredients, put on low heat for 3 minutes |
| psyllium, ½ tbsp sugar | | |
| 2 tbsp psyllium | 8 oz water | combined on low heat for 5 minutes |
| 1 g calcium lactate, 1 g | 200 g water | Mix 100 g of water with each ingredient, let sit overnight |
| sodium alginate | | then combine |
| 1 tbsp psyllium (diluted | 8 oz water | combined and stirred on low heat for 5 minutes, spread onto |
| recipe) | | wax paper to dry |
| 1 tbsp psyllium, ¾ tsp | 8 oz water | combined and stirred on low heat for 5 minutes, spread onto |
| tylose | | wax paper to dehydrate |
| 1 tbsp psyllium, ¾ tsp | 8 oz water | combined and stirred on low heat for 5 minutes, spread onto |
| tylose, 1 tbsp sugar | | wax paper to dehydrate |
| 1 g calcium lactate, 1 g | 200 g water | Mix 100 g of water with each ingredient, let sit overnight |
| sodium alginate | | then combine gently into a tray to form thin film |
| 1 tbsp psyllium (diluted | 8 oz water | combined and stirred on low heat for 5 minutes, spread onto |
| recipe) | | plastic wrap to dry |
| 1 g calcium lactate, 1 g | 200 g water | Mix 100 g of water with each ingredient, let sit overnight |
| sodium alginate | | then combine gently into a tray to form thin film |
| lg calcium lactate, 1 g | 200 g water | Mix 100 g of water with each ingredient, let sit overnight |
| sodium alginate | | then combine gently into a tray to form thin film, dehydrated |
| | | to film |
| 1 tbsp acacia sengal powder | 8 oz water | combine on low heat for 5 minutes |
| 1 tbsp acacia sengal powder, | 8 oz water | Combine on low heat for 5 minutes, spread on silicon baking |
| 1 tbsp psyllium | | sheet to dehyrdrate for 55 minutes at 200 F. |
| 1 tbsp psyllium, ¼ tsp guar | 8 oz water | combine on low heat for 5 minutes, spread on silicon baking |
| gum, ¼ tsp xanthum gum | | sheet to dehyrdrate for 4 hours at 175 F. |
| 2 tbsp tapioca | 1 cup water | Combine on low heat for 10 minutes, dehydrate at 225 F. |
| ¼ tsp tapioca, 2¼ tsp oat | 1 cup water | Combine on low heat for 10 minutes, dehydrate at 225 F. |
| 2 tsp tapioca, 2 tsp tapioca | 1 cup water | Combine on low heat for 10 minutes, dehydrate at 225 F. |
| 1 tbsp tapioca, 2 tbsp oat | 1 cup water | Combine on low heat for 10 minutes, dehydrate at 225 F. |
| 2 tbsp tapioca, 1 tbsp oat | 1 cup water | Combine on low heat for 10 minutes, dehydrate at 225 F. |
| 1 tbsp tapioca, 2 tbsp wheat | 1 cup water | Combine on low heat for 10 minutes, dehydrate at 225 F. |
| 2 tbsp potato starch | 1.5 cup water | Combine on low heat for 5 minutes, dehydrate at 225 F. |
| 1 tbsp psyllium, 1 tbsp | 1 cup water | Combine on low heat for 5 minutes, dehydrate at 225 F. |
| potato starch | | |
| 1 tbsp psyllium, 2 tsp potato | 1.5 cup water | Combine on low heat for 5 minutes, dehydrate at 225 F. |
| starch | | |
| 1 tsp psyllium, 2 tsp potato | 1.5 cup water | Combine on low heat for 5 minutes, dehydrate at 225 F. |
| starch | | |
| 2 tbsp arrowroot | 2 cups water | Combine on low heat for 5 minutes, dehydrate at 225 F. |
| 1 tbsp psyllium, 1 tbsp | 2 cups water | Combine on low heat for 5 minutes, dehydrate at 225 F. |
| arrowroot | | |
| 1 tbsp potato starch, 1 tbsp | 2 cups water | Combine on low heat for 5 minutes, dehydrate at 225 F. |
| arrowroot | | |
| 1 tbsp guar gum | 2 cups water | Combine on low heat for 5 minutes, dehydrate at 225 F. |
| ½ tsp guar gum | 1 cup water | Combine on low heat for 5 minutes, dehydrate at 225 F. |
| ½ tsp guar gum, 1 tbsp | 1.5 cup water | Combine on low heat for 5 minutes, dehydrate at 225 F. |
| psyllium | | |
| ½ tsp guar gum, 1 tbsp | 1.5 cup water | Combine on low heat for 5 minutes, dehydrate at 225 F. |
| arrowroot | | |
| 1 tbsp tapioca, ½ tsp guar | 1 cup water | Combine on low heat for 5 minutes, dehydrate at 225 F. |
| gum | | |
| ½ tsp guar gum, 1 tbsp | 2 cups water | Combine on low heat for 5 minutes, dehydrate at 225 F. |
| potato starch | | |
| ½ tsp guar gum, 1 tsp | 1 cup water | Combine on low heat for 5 minutes, dehydrate at 225 F. |
| psyllium | | |
| 1 tsp psyllium (grounded), | 1 cup water | Combine on low heat for 5 minutes, dehydrate at 225 F. |
| 1 tbsp potato starch | | |

Parameters evaluated included strength of adhesiveness to starch based external foods (e.g., tortilla), film formation ability, texture, consistency, opacity, dehydration ability, ability to solidify, brittleness, and viscosity. Table 8 details the viability for each adhesive composition as applied across these metrics.

TABLE 8

| Materials (from Table 7) | Parameter Assessment | Viability |
|---|---|---|
| ½ packet Jello Gelatin | thin and quite stretchy, sticks to itself and hands but not tortilla | Less |
| | | Viable |
| ¾ tsp tylose | did not form film, left crystallized tylose | Least |
| | | Viable |
| ¾ tsp tylose, 1 tbsp | crepe like consistency, with brittle edges | Less |
| cornstarch | | Viable |
| ¾ tsp tylose, 1 tbsp | wet crepe like consistency, very fragile to handle | Least |
| cornstarch, 2 tsp flour | | Viable |
| ¾ tsp tylose, 1 tbsp | rice noodle texture, still fragile not quite dehydrated enough? | Least |
| cornstarch, 4 tsp flour | | Viable |
| 1 tsp beef gelatin | created an edible tape, with plasticky texture that capable of | Most |
| | folding and bending, similar to backbone of normal tape | Viable |
| 1 tbsp psyllium husk, 1 tbsp | thickens into an amorphous mound, forms a thick film with | Less |
| benefiber | minimal dehydration | Viable |
| 1 tbsp psyllium husk, 1 tbsp | thickens into an amorphous mound, forms a thick film with | Less |
| benefiber, 1 tbsp maple | minimal dehydration, brown in color | Viable |
| syrup | | |
| 1 tsp psyllium husk, 1 tsp | aqueous and light in color | Less |
| benefiber, 6 tbsp sugar | | Viable |
| 1 tsp psyllium husk, 1 tsp | thicker and more honey in color | Less |
| benefiber, 6 tbsp sugar | | Viable |
| 1.5 tbsp benefiber | did not solidify even after cooling in fridge | Least |
| | | Viable |
| 6 tbsp benefiber, 1 tbsp | did not solidify even after cooling in fridge | Least |
| sugar | | Viable |
| 2 tbsp psyllium | gelatinized upon contact with water, dehydrated strip is | Most |
| | transparent, dry, fragile (saran wrap), stiff strip with rehydration | Viable |
| | potential | |
| 2 tbsp psyllium | gelatinized upon further stirring with water, dehydrated strip is | Most |
| | transparent and dry (saran wrap) | Viable |
| 1 tbsp psyllium, 1 tbsp sugar | forms a dry transparent strip, flexible, texture similar to fruit | Most |
| | rollup or taffy | Viable |
| 1 tbsp psyllium, 1 tbsp sugar | forms a dry transparent strip, flexible, texture similar to fruit | Most |
| | rollup or taffy | Viable |
| 1 tbsp psyllium, 1 tbsp sugar | forms a dry transparent strip, flexible, texture similar to fruit | Most |
| | rollup or taffy | Viable |
| 3 tbsp benefiber, ½ tbsp | forms a sticky film that is difficult to separate from film | Most |
| psyllium, ½ tbsp sugar | | Viable |
| 2 tbsp psyllium | difficult to spread thin, film is formed after dehydration | Most |
| | | Viable |
| 1 g calcium lactate, 1 g | formed gels | Most |
| sodium alginate | | Viable |
| 1 tbsp psyllium (diluted | attempt to improve texture, formed strips but unable to remove | Most |
| recipe) | from wax paper | Viable |
| 1 tbsp psyllium, ¾ tsp | texture not pleasant, taste blended with tortilla, weak | Less |
| tylose | | Viable |
| 1 tbsp psyllium, ¾ tsp | texture was more pleasant, sweet, strongest backbone | Most |
| tylose, 1 tbsp sugar | | Viable |
| 1 g calcium lactate, 1 g | thin film was formed, was not uniform thickness | Most |
| sodium alginate | | Viable |
| 1 tbsp psyllium (diluted | thinner and less of a chewy unpleasant texture, strips could be | Most |
| recipe) | removed | Viable |
| 1 g calcium lactate, 1 g | fresh alginate gel was thick and was too wet to handle with food, | Least |
| sodium alginate | could hold together a tortilla | Viable |
| 1 g calcium lactate, 1 g | thin film that curled at edges, not flexible initially but upon | Less |
| sodium alginate | rehydration it would return to more flexible bendable nature, | Viable |
| | rehydration takes time | |
| 1 tbsp acacia sengal powder | did not thicken | Least |
| | | Viable |
| 1 tbsp acacia sengal powder, | similar to plain psyllium recipe with clear glassy edges | Less |
| 1 tbsp psyllium | | Viable |
| 1 tbsp psyllium, ¼ tsp guar | not homogenous strips were made | Less |
| gum, ¼ tsp xanthum gum | | Viable |
| 2 tbsp tapioca | glassy shards | Least |
| | | Viable |
| ¼ tsp tapioca, 2¼ tsp oat | Thin, chalky, breaks easy | Less |
| | | Viable |
| 2 tsp tapioca, 2 tsp tapioca | Chalky, turns to powder, dissolves in water | Less |
| | | Viable |
| 1 tbsp tapioca, 2 tbsp oat | Brittle, crumbles, dissolves in water | Less |
| | | Viable |
| 2 tbsp tapioca, 1 tbsp oat | Brittle, powdery, dissolves in water | Less |
| | | Viable |
| 1 tbsp tapioca, 2 tbsp wheat | Bumpy, brittle, hard to peel off | Less |
| | | Viable |
| 2 tbsp potato starch | Slightly brittle but has potential (no taste and doesn't dissolve) | Less |
| | | Viable |
| 1 tbsp psyllium, 1 tbsp | Too brittle | Less |
| potato starch | | Viable |
| 1 tbsp psyllium, 2 tsp potato | Brittle in some spots not in others, doesn't dissolve | Less |
| starch | | Viable |
| 1 tsp psyllium, 2 tsp potato | Brittle in some spots not others | Less |
| starch | | Viable |
| 2 tbsp arrowroot | Brittle, doesn't dissolve | Less |
| | | Viable |
| 1 tbsp psyllium, 1 tbsp | Brittle in some spots not others | Less |
| arrowroot | | Viable |
| 1 tbsp potato starch, 1 tbsp | Brittle | Less |
| arrowroot | | Viable |
| 1 tbsp guar gum | Thick in middle, flexible edges | Less |
| | | Viable |
| ½ tsp guar gum | Very flexible, thin, doesn't dissolve in water | Less |
| | | Viable |
| ½ tsp guar gum, 1 tbsp | brittle, cracks easily, doesn't dissolve in water | Less |
| psyllium | | Viable |
| ½ tsp guar gum, 1 tbsp | Thin, brittle | Less |
| arrowroot | | Viable |
| 1 tbsp tapioca, ½ tsp guar | Thin like tissue paper, breaks easily | Less |
| gum | | Viable |
| ½ tsp guar gum, 1 tbsp | brittle | Less |
| potato starch | | Viable |
| ½ tsp guar gum, 1 tsp | edges thin frail and bubby, middle thick, brittle and crisp | Less |
| psyllium | | Viable |
| 1 tsp psyllium (grounded), | Took some time to thicken on stove, flexible when first dried but | Less |
| 1 tbsp potato starch | as it laid out it got brittle | Viable |

As can be seen, psyllium-based backbone formulations generally created the most viable backbone formulations using the parameters assessed.

Backbone formulations with plasticizer were also assessed. Table 9 provides the formulations measured and Table 10 provides the viability assessment.

TABLE 9

| Materials | Water | Process |
|---|---|---|
| 1 tbsp psyllium, ¼ tsp glycerol | 1 cup water | Combine ingredients, dehydrate for 24 hours |
| monostearate | | |
| 1 tbsp psyllium, ½ tsp glycerol | 1 cup water | Combine ingredients, dehydrate for 24 hours |
| monostearate | | |
| 1 tbsp psyllium, 1 tbsp glycerol | 1 cup water | Combine ingredients, dehydrate for 24 hours |
| monostearate | | |
| 1 tbsp swanson trifiber complex | 1 cup water | Combine ingredients, dehydrate for 24 hours |
| (9 capsules each of 450 mg psyllium, | | |
| 410 mg oat bran, 40 mg apple pectin | | |
| powder) | | |
| 1 tbsp psyllium, ⅛ tsp MCC | 1 cup water | Combine ingredients, dehydrate for 24 hours |
| (microcrystalline cellulose) | | |
| 1 tbsp psyllium, ¼ tsp sorbitol | 1 cup water | Combine ingredients, dehydrate for 24 hours |
| 1 tbsp psyllium, ½ tsp sorbitol | 1 cup water | Combine ingredients, dehydrate for 24 hours |
| 1 tbsp psyllium, ¼ tsp xylitol | 1 cup water | Combine ingredients, dehydrate for 24 hours |
| 1 tbsp psyllium, ½ tsp xylitol | 1 cup water | Combine ingredients, dehydrate for 24 hours |
| 1 tbsp psyllium, 1 tsp xylitol | 1 cup water | Combine ingredients, dehydrate for 24 hours |
| 1 tbsp psyllium, 2 tsp xylitol | 1 cup water | Combine ingredients, dehydrate for 24 hours |
| 1 tbsp psyllium, 3 tsp xylitol | 1 cup water | Combine ingredients, dehydrate for 24 hours |
| 1 tbsp psyllium, 1 tsp sorbitol | 1 cup water | Combine ingredients, dehydrate for 24 hours |
| 1 tbsp psyllium, 2 tsp sorbitol | 1 cup water | Combine ingredients, dehydrate for 24 hours |
| 1 tbsp psyllium, ¾ tsp sorbitol | 1 cup water | Combine ingredients, dehydrate for 24 hours |
| 1 tbsp psyllium, 1 tsp MCC | 1 cup water | Combine ingredients, dehydrate for 24 hours |
| 1 tbsp psyllium, 1 tsp CMC | 1 cup water | Combine ingredients, dehydrate for 24 hours |
| (carboxymethylcellulose) | | |
| 1 tbsp psyllium, ¾ tsp xylitol | 1 cup water | Combine ingredients, dehydrate for 24 hours |
| 1 tbsp psyllium, ¼ tsp CMC | 1 cup water | Combine ingredients, dehydrate for 24 hours |
| 1 tbsp psyllium, ½ tsp CMC | 1 cup water | Combine ingredients, dehydrate for 24 hours |

TABLE 10

| Materials (from Table 9) | Parameter Assessment | Viability |
|---|---|---|
| 1 tbsp psyllium, ¼ tsp glycerol | thick, sticky, wet to touch | Least Viable |
| monostearate | | |
| 1 tbsp psyllium, ½ tsp glycerol | drier film curls at edges with nonhomogeneous | Less Viable |
| monostearate | texture | |
| 1 tbsp psyllium, 1 tbsp glycerol | dry, flexible, rough textured film | Least Viable |
| monostearate | | |
| 1 tbsp swanson trifiber complex | dry, opaque, brown, brittle, easily flakes | Least Viable |
| (9 capsules each of 450 mg psyllium, | | |
| 410 mg oat bran, 40 mg apple pectin | | |
| powder) | | |
| 1 tbsp psyllium, ⅛ tsp MCC | forms film that is flaky and fragile to touch | Least Viable |
| (microcrystalline cellulose) | | |
| 1 tbsp psyllium, ¼ tsp sorbitol | forms a film that can bend but not quite flexible | Less Viable |
| 1 tbsp psyllium, ½ tsp sorbitol | forms a film that is more flexible than prior | Less Viable |
| | formulation | |
| 1 tbsp psyllium, ¼ tsp xylitol | forms a film that can bend but not quite flexible, | Less Viable |
| | curled up at the edges | |
| 1 tbsp psyllium, ½ tsp xylitol | forms a film that is more flexible than prior | Less Viable |
| | formulation, slightly wavy in drying | |
| 1 tbsp psyllium, 1 tsp xylitol | film that is quite flexible that bends with gravity | Most Viable |
| 1 tbsp psyllium, 2 tsp xylitol | film that is quite flexible and bends and fold | Most Viable |
| | with ease | |
| 1 tbsp psyllium, 3 tsp xylitol | wet film that sticks to itself and folds onto itself | Less Viable |
| | like saran wrap | |
| 1 tbsp psyllium, 1 tsp sorbitol | film that is quite flexible that bends with gravity | Most Viable |
| 1 tbsp psyllium, 2 tsp sorbitol | film that is quite flexible and bends and fold | Most Viable |
| | with ease | |
| 1 tbsp psyllium, ¾ tsp sorbitol | film that bends with ease and does not fold onto | Most Viable |
| | itself | |
| 1 tbsp psyllium, 1 tsp MCC | warped stiff film that folds with pressure | Less Viable |
| 1 tbsp psyllium, 1 tsp CMC | nonhomogeneous drying process, stiff film that | Less Viable |
| (carboxymethylcellulose) | bends with pressure | |
| 1 tbsp psyllium, ¾ tsp xylitol | film that bends to gravity, folds onto itself | Most Viable |
| 1 tbsp psyllium, ¼ tsp CMC | brittle, stiff, nonhomogeneous mixture | Least Viable |
| 1 tbsp psyllium, ½ tsp CMC | brittle, stiff, nonhomogeneous mixture | Least Viable |

Backbone formulations were also formulated with various adhesive compositions to determine the interplay between the layers and how they layers may affect the resultant viability if the composite adhesive films. Table 11 provides the formulations tested and Table 12 provides the viability assessment.

TABLE 11

| Materials | Water | Process |
|---|---|---|
| 1 tsp beef gelatin + tylose adhesive recipe | 2 tsp water | once dehydrated gelatin film spread |
| | | tylose gel on side |
| 1 tsp beef gelatin + tylose adhesive recipe | 2 tsp water | combined prior to dehydration |
| 2 tbsp psyllium + tylose adhesive recipe | 8 oz water | heated all ingredients for 5 minutes, |
| | | placed tylose adhesive on backbone post |
| | | dehydration |
| 2 tbsp psyllium + tylose adhesive recipe | 8 oz water | heated all ingredients for 10 minutes, |
| | | placed tylose adhesive on backbone post |
| | | dehydration |
| 2 tbsp psyllium + ¾ tsp tylose | 8 oz water | combined fiber + water for low heat 4 |
| | | minutes, add tylose and blend for 30 secs |
| 2 tbsp psyllium + ¾ tsp tylose + 1 tbsp sugar | 8 oz water | combined fiber + water + sugar for low |
| | | heat 4 minutes, add tylose and blend for |
| | | 30 secs |
| 2 tbsp beef gelatin + tylose adhesive recipe | 4 tbsp water | combined prior to dehydration |

TABLE 12

| Materials | Notes | Viability |
|---|---|---|
| 1 tsp beef gelatin + tylose | tylose adhesive disintegrates the backbone to solubility of | Least Viable |
| adhesive recipe | water | |
| 1 tsp beef gelatin + tylose | unable to pull from foil, but is sticky to touch | Least Viable |
| adhesive recipe | | |
| 2 tbsp psyllium + tylose | film stayed homogenous and stable during adhesive | Most Viable |
| adhesive recipe | application, strip and adhesive were functional and performed | |
| | well during pull test on paper | |
| 2 tbsp psyllium + tylose | film stayed homogenous and stable during adhesive | Most Viable |
| adhesive recipe | application, strip and adhesive were functional and performed | |
| | well during pull test on paper | |
| 2 tbsp psyllium + ¾ tsp | formed a transparent strip that could be reactivated under | Most Viable |
| tylose | water | |
| 2 tbsp psyllium + ¾ tsp | very adhesive, formed a transparent strip that could | Most Viable |
| tylose + 1 tbsp sugar | reactivated under water | |
| 2 tbsp beef gelatin + | forms transparent strip with non-homogeneously dispersed | Less Viable |
| tylose adhesive recipe | bubbles, not sticky | |

As can be seen, viability of these formulations as an adhesive composite film varied across the different formulations tested. Surprisingly, psyllium-based backbones (e.g., with a plasticizer selected from sorbitol and/or xylitol) produced the most viable composite adhesive films when coupled with tylose based adhesives. Furthermore, a concentration dependence was identified in relation to film viability.

### SPECIFIC EMBODIMENTS

Non-limiting specific embodiments are described below each of which is considered to be within the present disclosure.

Embodiment 1. One-, two- or three- or multi-layer material made up of at least one layer of an edible, polymer mixture or blend of both water-soluble and water-insoluble food-grade polymer and a third edible soluble, food-grade polymer that either is adhesive or becomes adhesive after exposure to water for a period of 1 to 30 seconds.

Embodiment 2. The edible, water-soluble polymer of Embodiment 1 that is made beta glucan, wheat dextrin, calcium polycarbonphil and similar compounds or mixtures of such compounds that come from oats, peas, beans, apples, citrus fruits, carrots, barley, psyllium, brussels sprouts, turnips, pears, figs, apricots, or similar fruits and vegetables.

Embodiment 3. The edible, high-strength, water-insoluble polymer of Embodiment 1 can be materials such as cellulose, methylcellulose, wheat bran, lignin, psyllium husk or any combination of such substances.

Embodiment 4. The edible, high-strength, cross-linked mixture or blend of water-soluble and water-insoluble polymers of Embodiment 1 can be either a mixture of water-soluble polymers of Embodiment 2 and a water-insoluble polymers of Embodiment 3 or it can be a natural material that contains both water-soluble a water-insoluble polymers such as Psyllium.

Embodiment 5. The edible, high-strength, cross-linked polymer of embodiment 1 that is made by crosslinking Sodium Alginate with a Magnesium- or Calcium-containing salt such as Calcium Chloride, Magnesium Chloride, Calcium Lactate or Magnesium Gluconate or similar compounds.

Embodiment 6. The edible, adhesive polymer of embodiment 1 that is made from Sodium Carboxymethyl Cellulose (Na-CMC, or just CMC), Gum Tragacanth, Xanthan gum, Karaya gum, or similar substances.

Embodiment 7. The material of Embodiment 1 can be a single layer of material that is prepared by cross-linking the water-soluble and water-insoluble polymers of Embodiment 1 and after the cross-linking reaction is complete, the water-soluble adhesive polymer material of Embodiment 1 can be added and then this material processed into a thin film and allowed to dry either naturally or in an oven.

Embodiment 8. A two-, three, or multi-layer material of Embodiment 1 can prepared by crosslinking together the water-soluble and water-insoluble polymers of Embodiment 1 and then forming a thin film and allowed to dry either naturally or in an oven and then having this high-strength layer coated on one or both sides by a solution of the water-soluble adhesive material of Embodiment 1 and then having this two- or three-layer material dry either at room temperature or at an elevated temperature in an oven or by the convective flow of hot air.

Embodiment 9. An edible adhesive tape which is applied to a food item wherein the edible adhesive tape holds the food item together or in-place during consumption.

Embodiment 10. The edible adhesive tape of embodiment 1, wherein the edible adhesive tape can be activated via water or heat.

Embodiment 11. The edible adhesive tape of embodiment 1 wherein the food item which the tape is applied to is chosen from the following group: burrito, taco, wrap, tortilla, sandwich, pita, gyro, pinwheel, enchilada, durum.

Embodiment 12. The edible adhesive tape of embodiment 1 wherein the edible adhesive tape contains seasoning as means of flavoring the food item it's holding together

Embodiment 13. A method of making an edible adhesive film, wherein the backbone and adhesive coating are created separately and joined for improved adhesive properties, comprising:
(a) heating a source of dietary polymer with a sugar, and solvent to provide a backbone mixture;
(b) applying said backbone mixture to packaging for dehydration; and,
(c) blending an emulsifier and solvent to provide an adhesive coating blend; and,
(d) applying said coating blend to said dehydrated backbone mixture and dehydrate joined edible tape adhesive together.

Embodiment 14. A method of making the edible tape backbone, wherein the backbone is composed of a dietary polymer, sugar, and emulsifier, comprising:
(a) heating a source of dietary polymer (fiber) with a sugar and solvent to provide a backbone blend; and,
(b) blending the said backbone blend with an emulsifier to create a backbone mixture;
and,
(c) applying said backbone mixture to packaging for dehydration

Embodiment 15. The method of claim 11, wherein the dehydration comprises baking at low heat. (range of 150-250° F.).

Embodiment 16. A method of making an edible adhesive of Embodiment 1, wherein the backbone and adhesive coating are created separately and joined for improved adhesive properties, comprising:
(a) heating a source of dietary polymer with a sugar, and solvent to provide a backbone mixture; and,
(b) applying said backbone mixture to packaging for dehydration; and,
(c) blending an emulsifier and solvent to provide an adhesive coating blend; and,
(d) applying said coating blend to said dehydrated backbone mixture and dehydrate joined edible tape adhesive together

Embodiment 17. A method of making the edible tape backbone, wherein the backbone is composed of a dietary polymer, sugar, and emulsifier, comprising:
(a) heating a source of dietary polymer with a sugar and solvent to provide a backbone blend; and,
(b) blending the said backbone blend with an emulsifier to create a backbone mixture; and,
(c) applying said backbone mixture to packaging for dehydration

Embodiment 18. The method of making an edible tape backbone of embodiment 9, wherein the dehydration comprises baking at low heat.

Embodiment 19. The edible adhesive tape of embodiment 1 wherein the edible adhesive tape can be activated via water or heat

Embodiment 20. The edible adhesive tape of embodiment 1 wherein the food item which the tape is applied to is chosen from the following group: burrito, taco, wrap, tortilla, sandwich, pita, gyro, pinwheel, enchilada, durum.

Embodiment 21. The edible adhesive tape of embodiment 1 wherein the edible adhesive tape contains seasoning as means of flavoring the food item it's holding together.

Embodiment 22. An edible food adhesive film comprising:
a. a layer of an edible backbone;
b. a layer of an edible adhesive placed on the edible backbone, the adhesive configured to adhere to the item of food;
wherein a user stabilizes the item of the food with the adhesive film and consumes both the item of food and the adhesive film.

Embodiment 23. The edible food adhesive film of Embodiment 22, wherein the backbone layer is made from a polymer.

Embodiment 24. The edible food adhesive film of Embodiment 22, wherein the backbone layer is made from a high-strength polymer (such as Psyllium Backbone, sodium alginate).

Embodiment 25. The edible food adhesive film of Embodiment 22, wherein the backbone layer is made from a cross-linked polymer mixture. (such as Sodium Alginate, pectin/chitosan crosslinked with transglutaminase).

Embodiment 26. The edible food adhesive film of Embodiment 22, wherein the backbone layer is made from a blend of both water-soluble and water-insoluble food-grade polymer.

Embodiment 27. The edible food adhesive film of Embodiment 22, wherein the adhesive layer becomes adhesive after exposure contact with water.

Embodiment 28. The edible food adhesive film of Embodiment 22, wherein the adhesive layer becomes adhesive after exposure to water for 1 to 30 seconds

Embodiment 29. The edible food adhesive film of Embodiment 22, wherein the polymer is selected from the group consisting of one or more of beta glucan, wheat dextrin, and calcium polycarbonphil.

Embodiment 30. The edible food adhesive film of Embodiment 22, wherein the polymer is derived from one or more of the following fruits and vegetables: oats, peas, beans, apples, citrus fruits, carrots, barley, psyllium, brussels sprouts, turnips, pears, figs, apricots.

Embodiment 31. The edible food adhesive film of Embodiment 22, wherein the polymer is selected from the group consisting of one or more of cellulose, methylcellulose, wheat bran, lignin, psyllium husk.

Embodiment 32. The edible food adhesive film of Embodiment 22, wherein the polymer is made from Sodium Alginate.

Embodiment 33. The edible food adhesive film of Embodiment 32, wherein the polymer is made by crosslinking Sodium Alginate with a Magnesium- or Calcium-containing salt such as Calcium Chloride, Magnesium Chloride, Calcium Lactate or Magnesium Gluconate or similar compounds.

Embodiment 34. The edible food adhesive film of Embodiment 22, wherein the polymer is made from Sodium Carboxymethyl Cellulose (Na-CMC, or just CMC), Gum Tragacanth, Xanthan gum, and Karaya gum.

Embodiment 35. The edible food adhesive film of Embodiment 22, wherein the adhesive film comprises Calcium Lactate, Sodium Alginate and tylose, or a derivative thereof.

Embodiment 36. The edible food adhesive film of Embodiment 22, wherein the adhesive film comprises Psyllium, sugar, tylose, or a derivative thereof.

Embodiment 37. The edible food adhesive film of Embodiment 22, wherein the adhesive layer is made from tylose.

Embodiment 38. The edible food adhesive film of Embodiment 22, wherein the adhesive layer is a full layer.

Embodiment 39. The edible food adhesive film of Embodiment 22, wherein the adhesive layer is a partial layer.

Embodiment 40. The edible food adhesive film of Embodiment 22, wherein the adhesive film comprises 5% to 50% of a dietary polymer, 0% to 20% sugar, and 0% to 50% adhesive polymers

Embodiment 41. The edible food adhesive film of Embodiment 40, where the range is 1-10% polymer in hydrated form, 1-5% sugar, and 1-10% adhesive polymer, w/w.

Embodiment 42. The edible food adhesive film of Embodiment 22, wherein the backbone is made by a process comprising the steps of:
a. cross-linking the water-soluble and water-insoluble polymers,
b. adding the water-soluble adhesive polymer material;
c. processing into a thin film; and
d. allowing to dry.

Embodiment 43. An edible backbone prepared by a process comprising the steps of:
a) crosslinking together the water-soluble and water-insoluble polymers;
b) forming a thin film;
c) allowing to dry;
d) coating on one or both sides by a solution of the water-soluble adhesive material; and;
e) drying.

Embodiment 44. The edible food adhesive film of Embodiment 22, wherein the backbone is made by a process comprising the steps of:
e. cross-linking polymers,
f. adding the water-soluble adhesive polymer material;
g. processing into a thin film; and
h. allowing to dry.

Embodiment 45. An edible backbone prepared by a process comprising the steps of:
a) crosslinking polymers;
b) forming a thin film;
c) allowing to dry;
d) coating on one or both sides by a solution of the water-soluble adhesive material; and;
e) drying.

Embodiment 46. The edible food adhesive film of Embodiment 22, further comprising an additional layer of an edible adhesive on other side of the edible backbone. (there is a layer of adhesive, layer of backbone, then another layer of adhesive, basically double sided tape.)

Embodiment 47. The edible food adhesive film of Embodiment 22, further comprising a flavoring and/or coloring additive.

Embodiment 48. The edible food adhesive film of Embodiment 22, wherein the adhesive layer is preactivated before use.

Embodiment 49. The edible food adhesive film of Embodiment 22, wherein the adhesive layer is heat activated.

Embodiment 50. The edible food adhesive film prepared by any of the preceding processes and/or ingredients.

Embodiment 51. The edible adhesive prepared by any of the preceding processes and/or ingredients.

As various changes can be made in the above-described subject matter without departing from the scope and spirit of the present disclosure, it is intended that all subject matter contained in the above description, or defined in the appended claims, be interpreted as descriptive and illustrative of the present disclosure. Many modifications and variations of the present disclosure are possible in light of the above teachings. Accordingly, the present description is intended to embrace all such alternatives, modifications and variances which fall within the scope of the appended claims.

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure

1. An adhesive composite film comprising:
a. a layer of an edible backbone;
b. a layer of an edible adhesive placed on the edible backbone, the adhesive configured to adhere to an item of food.

2. The adhesive composite film of claim 1, wherein the backbone layer comprises a polymer.

3. The adhesive composite film of claim 1, wherein the backbone comprises psyllium.

4. The adhesive composite film of claim 1, wherein the layer of edible backbone comprises a plasticizer.

5. The adhesive composite film of claim 4, wherein the plasticizer is selected from xylitol and/or sorbitol.

6. The adhesive composite film of claim 1, wherein edible backbone comprises a dietary fiber and the volume ratio of dietary fiber to plasticizer is from 20:1 to 1:20.

7. The adhesive composite film of claim 1, wherein the adhesive layer becomes adhesive after exposure contact with water.

8. The adhesive composite film of claim 1, wherein the adhesive film comprises tylose powder, hydroxyalkyl cellulose, a sweetener, a dextrin, or a combination thereof.

9. The adhesive composite film of claim 1, wherein the adhesive layer comprises tylose.

10. The adhesive composite film of claim 1, further comprising an additional layer of an edible adhesive on both sides of the layer of the edible backbone.

11. The adhesive composite film of claim 1, further comprising a flavoring and/or coloring additive in the layer of edible backbone and/or the layer of edible adhesive.

12. The adhesive composite film of claim 1 for adhering to food.

13. The adhesive composite film according to claim 1, wherein:
a) the layer of edible backbone has a height of less than 0.15 mm; and/or
b) the layer of edible adhesive has a height of less than 0.15 mm.

14. The adhesive composite film according to claim 1, attached to a substrate material.

15. A food product comprising an external barrier material comprising the adhesive composite film according to claim 1 adhered to said external barrier material.

16. The food product according to claim 15, wherein the adhesive composite material adheres to two portions of the external barrier material and forms a union between the two portions.

17. A method of forming an adhesive composite film comprising:
a) mixing a dietary fiber, optionally a plasticizer, and optionally a sweetener in a medium to form a backbone composition;
b) forming a planar structure from the backbone composition and allowing the planar structure to dehydrate; and
c) placing an adhesive composition onto a surface of the planar structure (e.g., the dehydrated planar structure).

18. A method of preparing a foodstuff comprising applying the adhesive composite film according to claim 1 to a first portion of an external barrier material of the foodstuff.

19. The method according to claim 18, further comprising applying the adhesive composite film to a second portion of the external barrier material to form union between the two portions of the external barrier material.
